(19) United States
(12) Patent Application Publication
(10) Pub. No.: US 2019/0385610 A1
(43) Pub. Date: Dec. 19, 2019

(54) METHODS AND SYSTEMS FOR TRANSCRIPTION

(71) Applicant: Veritone, Inc., Costa Mesa, CA (US)

(72) Inventors: Chad Steelberg, Newport Beach, CA (US); Wolf Kohn, Costa Mesa, CA (US); Yanfang Shen, Costa Mesa, CA (US); Cornelius Raths, Costa Mesa, CA (US); Michael Lazarus, Costa Mesa, CA (US); Peter Nguyen, Costa Mesa, CA (US)

(21) Appl. No.: 16/215,371

(22) Filed: Dec. 10, 2018

Related U.S. Application Data
(63) Continuation-in-part of application No. 16/052,459, filed on Aug. 1, 2018.
(60) Provisional application No. 62/735,765, filed on Sep. 24, 2018.
(60) Provisional application No. 62/596,702, filed on Dec. 8, 2017.

(51) Int. Cl. G10L 15/26; G06N 20/00; G10L 25/24; G10L 25/90; G10L 15/02; G10L 15/22

(52) U.S. Cl. CPC G10L 15/26; G06N 20/00; G10L 25/24; G10L 2015/025; G10L 15/02; G10L 15/22; G10L 25/90

(57) ABSTRACT

Methods and systems for transcribing a media file using reinforcement learning are provided. In one aspect, the method includes: identifying a low confidence of accuracy portion from a transcription result of the media file; constructing a phoneme sequence that includes an audio segment corresponding to the identified low confidence of accuracy portion, based on at least on a reward function; creating a new audio waveform based at least on the constructed phoneme sequence; and generating a new transcription using a transcription engine based on the new audio waveform.

### CROSS-REFERENCE TO RELATED APPLICATIONS

This present application is a continuation-in-part of U.S. patent application Ser. No. 16/052,459, filed Aug. 1, 2018, and claims priority to and the benefit of U.S. Provisional Application No. 62/735,765, filed on Sep. 24, 2018, and to U.S. Provisional Application No. 62/596,702, filed on Dec. 8, 2017, the disclosures of all of which are incorporated herein by reference in their entireties for all purposes.

### BACKGROUND

Based on one estimate, 90% of all data in the world today are generated during the last two years. Quantitively, that is more than 2.5 quintillion bytes of data are being generated every day; and this rate is accelerating. This estimate does not include ephemeral media such as live radio and video broadcasts, most of which are not stored.

To be competitive in the current business climate, businesses should process and analyze big data to discover market trends, customer behaviors, and other useful indicators relating to their markets, product, and/or services. Conventional business intelligence methods traditionally rely on data collected by data warehouses, which is mainly structured data of limited scope (e.g., data collected from surveys and at point of sales). As such, businesses must explore big data (e.g., structured, unstructured, and semi-structured data) to gain a better understanding of their markets and customers. However, gathering, processing, and analyzing big data is a tremendous task to take on for any corporation.

Additionally, it is estimated that about 80% of the world data is unreadable by machines. Ignoring this large portion of unreadable data could potentially mean ignoring 80% of the additional data points. Accordingly, to conduct proper business intelligence studies, businesses need a way to collect, process, and analyze big data, including machine unreadable data.

### SUMMARY

Provided herein are embodiments of systems and methods for transcribing a media file using reinforcement learning. One of the methods includes: identifying a low confidence of accuracy portion from a transcription result of the media file; constructing a phoneme sequence based at least on an audio segment corresponding to the identified low confidence of accuracy portion, based on at least on a reward function; creating a new audio waveform based at least on the constructed phoneme sequence; and generating a new transcription based at least on the new audio waveform.

The method further comprises: generating a string of cumulants comprising of one or more transcription portions preceding and following the low confidence of accuracy portion; and generating a reward function based at least on one or more characteristics of the transcription engine. The reward function comprises solving a Bellman equation. The Bellman equation can include a Dempster Shafer possibility transition matrix.

The reward function can also comprise a function of a state and an action vector, wherein the action vector comprises one or more parameters consisting of a treble, a bass, an average amplitude, a deviation, a frequency discriminant, coefficient of amplitude modulation, coefficient of phase modulation, a waveform frequency, a pitch, a spectral flax, and mel frequency cepstral coefficients (MFCC) of the waveform.

The confidence value (e.g., confidence of accuracy value) of each transcribed portion can be calculated based at least on one or more of ground truth data, wavelet transform coefficients, entropy of the signal, and an energy distribution of an audio segment corresponding to the low confidence of accuracy portion.

One of the disclosed systems includes: a transcription engine; a classifier module configured to identify a first low-accuracy transcribed portion, wherein the first low-accuracy has a confidence of accuracy value below an accuracy threshold; a cumulant module configured to generate a cumulant string based on the first low-accuracy transcribed portion; a reinforcement learning (RL) module configured to generate a reward function based on one or more characteristics of the transcription engine; a phoneme sequence construction module configured to construct one or more phoneme sequences based on the reward function and the cumulant string; and a microphone module configured to generate an audio waveform from the one or more phoneme sequences, wherein the transcription engine is configured to generate transcription based on the audio waveform.

Also provided herein are embodiments of systems and methods for transcribing a media file. One of the methods includes: receiving, from a first transcription engine, one or more transcribed portions of a media file; identifying, by a transcription analyzer, a first transcribed portion, from the one or more transcribed portions; requesting analysis on the first transcribed portion; receiving, in response to requesting for analysis, an analysis result having a revised-transcription portion of the first transcribed portion; and replacing the first transcribed portion with the revised-transcription portion. The first transcribed portion can have a confidence of accuracy value below a predetermined threshold.

The method also includes, prior to the request for analysis on the first transcribed portion, sending the first transcribed portion to a successive plurality of transcription engines; receiving successive transcribed portions from the successive plurality of transcription engines; and replacing the first transcribed portion with one of the received successive transcribed portions based on a confidence value of the one of the received successive transcribed portions. The method further includes: training a machine learning model using a training data set with low-confidence segments and corresponding ground truth data; identifying a second transcribed portion having a confidence value below the predetermined threshold; and re-transcribing a segment of the media file that corresponds with the second transcribed portion using the trained machine learning model.

Also provided is a method for transcribing a media file, the method includes: identifying a first transcribed portion, from the one or more transcribed portions, having a confidence of accuracy value below a first predetermined threshold; requesting analysis on the first transcribed portion; receiving, in response to requesting for analysis, a revised-transcription portion of the first transcribed portion; and replacing the first transcribed portion with the revised-transcription portion.

The revised-transcription portion can be one or more parts of the first transcribed potion that have been revised. In some embodiments, transcription analyzer can be used to identify the first transcribed portion having a confidence of accuracy value below a first predetermined threshold.

In some embodiments, requesting analysis on the first transcribed portion comprises: constructing a phoneme sequence that includes an audio segment corresponding to the first transcribed portion, based at least on a reward function; creating a new audio waveform based at least on the constructed phoneme sequence; and generating a new transcription for the first transcribed portion based at least on the new audio waveform.

The method further includes: generating a string of cumulants comprising of one or more portions preceding and following the first transcribed portion; and generating a reward function based at least on the string of cumulants. Generating the reward function can include solving a Bellman equation using backward induction.

Other features and advantages of the present invention will be or will become apparent to one with skill in the art upon examination of the following figures and detailed description, which illustrate, by way of examples, the principles of the present invention.

### BRIEF DESCRIPTION OF THE DRAWINGS

The present invention may be better understood by referring to the following figures. The components in the figures are not necessarily to scale, emphasis instead being placed upon illustrating the principles of the disclosure. In the figures, like reference numerals designate corresponding parts throughout the different views.

FIG. 1 illustrates a high-level flow diagram illustrating a process for optimizing transcription engines in accordance with some aspects of the disclosure.

FIG. 2 illustrates a flow diagram illustrating a process for training a transcription engine in accordance with some aspects of the disclosure.

FIG. 3 illustrates a flow diagram illustrating a process to improve transcription models and resulting transcriptions in accordance with some aspects of the disclosure.

FIG. 4 illustrates a flow diagram illustrating a process to for training a micro engine and for transcribing a segment of a media file resulting transcriptions in accordance with some aspects of the disclosure.

FIG. 5 illustrates a system and/or process flow diagram for transcribing a media file using reinforcement learning in accordance with some aspects of the disclosure.

FIG. 6 illustrates an exemplary time frequency decomposition of a waveform.

FIG. 7A illustrates a frequency response of a microphone in accordance with some aspects of the disclosure.

FIG. 7B illustrates a polar diagram of a microphone module in accordance in accordance with some aspects of the disclosure.

FIG. 7C illustrates the electrical characteristics of a microphone module in accordance with some aspects of the disclosure.

FIGS. 8A-8B illustrate flow diagrams of processes for transcribing a media file using reinforcement learning in accordance with some aspects of the disclosure.

FIG. 9 illustrates a system diagram of the reinforcement learning system in accordance with some aspects of the disclosure.

FIG. 10 illustrates a diagram illustrating a process performing human intelligence task services in accordance with some aspects of the disclosure.

FIG. 11 illustrates a system diagram of the transcription system in accordance with some aspects of the disclosure.

FIG. 12 is a diagram illustrating an exemplary hardware implementation for each of the transcription and the reinforcement learning systems in accordance with some aspects of the disclosure.

### DETAILED DESCRIPTION

### Overview

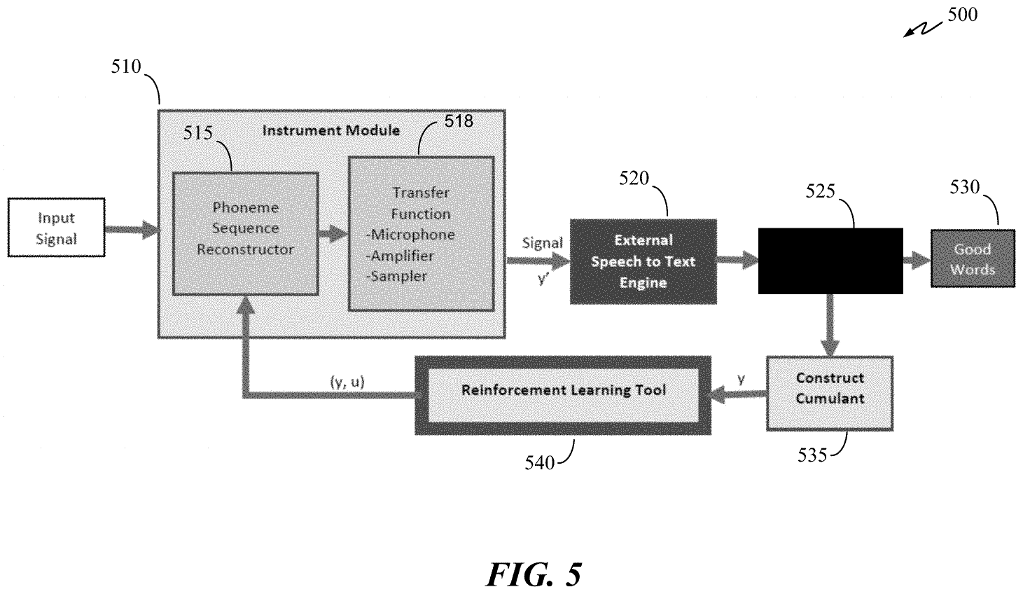

Conventional methods for transcribing a media file are typically done in a single iteration by a single transcription engine. In other words, transcriptions are typically performed by feeding the input data (e.g., input media file) into a transcription engine, and a final transcribed text is created without any feedback on the final transcription. As a result, the transcription engine has no opportunity and means to ingest any feedback and to create an improved transcription. Typically, if the transcription engine performs poorly, a new transcription engine will be selected to transcribe the same input data in an attempt to obtain a better transcription. The disclosed systems and methods provide opportunities for a segment of the input media file to be automatically re-analyzed, re-transcribed, and/or modified for re-transcription using a reinforcement learning enabled transcription model (see FIG. 5). The segment can also be re-directed to a human intelligence task (HIT) service for verification and/or modification before reentering the transcription process of the input media file.

Transcription outputs from a transcription engine can be analyzed to determine a confidence of accuracy or an accuracy value. The outputs may comprise a plurality of transcribed portions of the input media file. Each transcribed portion corresponds to a segment of the input media file. If the confidence of accuracy of any transcribed portion is below a given accuracy threshold, then another transcription engine may be selected from the list of candidate transcription engines to re-transcribe the low confidence segment that corresponds to the transcribed portion having a low confidence of accuracy. A low confidence segment is a segment of the original input media file where its corresponding transcribed portion has a confidence of accuracy below a given accuracy threshold. A low confidence segment can correspond to a transcribed portion having one or more words. Stated differently, a low confidence segment can include one or more spoken words of the input audio file (e.g., input media file).

When a low confidence segment of input media file is identified, the low confidence segment or the entire input media file can be re-transcribed using another engine. After a new transcription engine is selected to re-transcribe the low confidence segment or the entire input media file, the input media file will have undergone at least two stages of transcription. Each subsequent transcription stage is generally more accurate than the previous transcription stage because the transcripts generated during previous stage(s) can be used as inputs to each subsequent transcription stage. However, the input media file can have a certain audio segment (with a certain audio waveform) that cannot be accurately transcribed even after several cycles (e.g., 5 or 10 cycles). Audio segments with transcribed portions having a low confidence of accuracy after many cycles can be referred to as persistently low confidence segments. Persistently low confidence segments can be re-analyzed by a HIT service or can be re-transcribed using the disclosed reinforcement learning transcription technology (e.g., reinforcement learning transcription methods and systems). The disclosed reinforcement learning transcription technology uses feedback to modify an audio waveform based at least on characteristics of an open transcription engine, whose internal characteristics are accessible and can be evaluated. An open engine can be an engine developed in-house or a third party's engine with appropriate permission to assess the engine's characteristics (e.g., hyperparameters, weights of nodes, and outputs of hidden layers).

Described herein are methods and systems for performing transcription in an iterative fashion using reinforcement learning. On a high level, the transcription method and system with reinforcement learning has the capability to ingest feedback, in the form of a reward function, to generate a revised (improved) transcription based on the received reward function. The revised transcription is then analyzed, and a second reward function is generated as feedback to the transcription engine, which then uses the second reward function to generate yet another revised transcription. This process is repeated until the desired accuracy threshold for the transcription is reached. The reward function may be generated using dynamic approximation characterized by a Dempster Shafer possibility transition matrix, rather than a Markov transition (probability) matrix. This distinction is important and will be further discussed herein. In some embodiments, the disclosed transcription method and system with reinforcement learning can be performed by one or more transcription engines. In some embodiments, the disclosed transcription method and system with reinforcement learning can be performed by a single transcription engine.

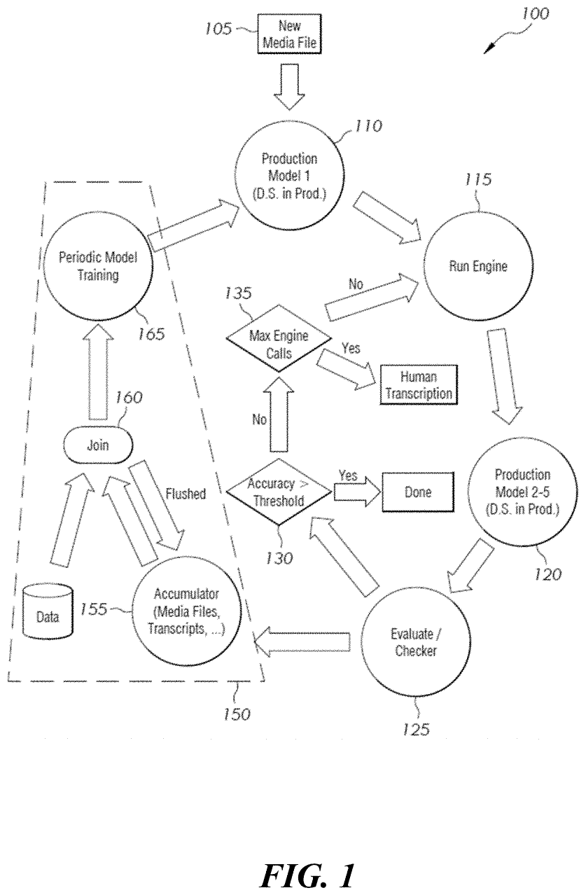

FIG. 1 is a high-level flow diagram depicting a process 100 for training transcription models, and for optimizing the selection of transcription engine(s) to transcribe media files in accordance with some embodiments of the disclosure. Process 100 can use a combination of preprocessors, machine learning models, transcription engines to generate one or more optimal transcripts. Media files as used herein may include audio data, image data, video data, or a combination thereof.

Transcripts may generally include transcribed texts of the audio portion of the media files. Transcript may also generally include features of the image portions of the media files. Transcripts may be generated and stored in segments having start times, end times, duration, text specific metadata, etc. Process 100 may use one or more network-connected servers, each including one or more processors and non-transitory computer readable memory storing instructions that when executed cause the processors to: use multiple preprocessors (data processing modules) to process a segment of an input media file (or the entire input media file)) for features identification and extraction, and to create a features profile for the segment of the input media file; train one or more neural network transcription models to identify one or more best candidate engines based on the features profile of the segment of the input media file.

A transcription neural network model (e.g., an engine, a model) can include one or more machine learning algorithms. A machine learning algorithm is an algorithm that is able to learn from data. For example, a computer program is said to learn from experience ‘E’ with respect to some class of tasks ‘T’ and performance measure ‘P’, if its performance at tasks in ‘T’, as measured by ‘P’, improves with experience ‘E’. Examples of machine learning algorithm may include, but not limited to: a deep learning neural network; a feedforward neural network, a recurrent neural network, a support vector machine learning neural network, and a generative adversarial neural network.

Process 100 starts at 105 where an input media file to be transcribed is received and processed by a plurality of data preprocessors, which can include, but not limited to, an audio analysis preprocessor that is configured to extract audio features such as mel-frequency cepstral coefficients (MFCC). The input media file may be a multimedia file containing audio data, image data, video data, external data such as, but not limited to, metadata (e.g., knowledge from previous media files, previous transcripts, confidence indicator), or a combination thereof.

Once the input media file is received, it can go through several preprocessors to condition, normalize, and/or to extract features in the content (data) of the input media file prior to being used as inputs of a transcription model. A features profile can be generated for the input media file. In some embodiments, a features profile can be generated for a portion of the input media file. For example, if the input media file is segmented (for transcription by individual segment) into four segments, four features profiles can be created—one for each segment. A features profile can include audio features such as, but not limited to, pitch (frequency), rhythm, noise ratios, length of sounds, intensity, relative power, silence, volume distribution, pitch contour, and MFCCs. A features profile may include relationships data between words, sentiment, recognized speech, accent, topics (e.g., sports, documentary, romance, sci-fi, politics, legal). Image features may include structures such as, but not limited to, points, edges, and shapes defined in terms of curves or boundaries between different image regions. Video features may include color (RGB pixel values), intensity, edge detection value, corner detection value, linear edge detection value, ridge detection value, valley detection value, etc.

At 110, an initial transcription neural network model can be used to select an initial transcription engine for transcribing the input media file (or a portion of the input media file). The initial a transcription neural network model (“transcription model”) that can be previously trained. Based the features profile of the input media file, the transcription model may then use one or more machine learning algorithms to generate a list of one or more transcription engines (candidate engines) with the highest predicted transcription accuracy. The one or more machine learning algorithms may include, but not limited to: a deep learning neural network; a gradient boosting algorithm (which may also be referred to as gradient boosted trees), and a random forest algorithm. In some embodiments, all three of the mentioned machine learning algorithms may be used—using model stacking—to create a multi-model.

In some embodiments, the transcription model may generate a list of one or more candidate transcription engines with the highest predicted accuracy that may be used to transcribe the content of the input media file received at 105. At 115, an initial transcription engine may be selected from the plurality of candidate engines to use in the initial round of transcription of the input media file. The selection of the initial transcription engine may provide efficient input data for the subsequent cycles. In some embodiments, the transcription engine can be selected based on the highest predicted transcription accuracy of the engine.

At 120, the output of the selected transcription engine may be further analyzed by one or more natural language preprocessors once the initial transcription of the media file (or portion of the media file) is available. In some embodiments, a natural language preprocessor may be used to extract relationships between words, identify and analyze sentiment, recognize speech, and categorize topics. Each one of the extracted relationships, identified sentiments, recognized speech, and/or categorized topics may be added as a feature of a features profile of the input media file.

At 125, at least another cycle of modeling can be performed. In this stage, the output of the selected transcription engine (transcription produced in the first cycle) may be analyzed for accuracy. If the output has an accuracy below an accuracy threshold, it can be reused as an input to one or more transcription models for the next cycle.

In some embodiments, the transcription model used at 125 may be the same transcription model at 110. Alternatively, a different transcription model may be used. Further, at 125, the transcription model may generate a list of one or more candidate transcription engines. Each candidate engine has a predicted accuracy for transcribing the input media file. As more cycles of modeling and transcription are performed, the list of candidate transcription engines may be improved.

In some embodiments, the transcription engine with the highest predicted accuracy may be selected to transcribe one or more segments of the input media file. Depending on the size or type of the input media file, the input media file may be divided into one or more segments. The outputs (transcription of the input media file) from the selected transcription engine may then be analyzed to determine a confidence of accuracy or an accuracy value. The outputs may comprise a plurality of transcribed portions of the media file. Each transcribed portion corresponds to a segment of the input media file. At 130, if the confidence of accuracy of any transcribed portion is below a given accuracy threshold, then another transcription engine may be selected from the list of candidate transcription engines to re-transcribe the low confidence segment that corresponds to the transcribed portion having a low confidence of accuracy. A low confidence segment is a segment of the original input media file where its corresponding transcribed portion has a confidence of accuracy below a given accuracy threshold. In some embodiments, when a low confidence segment of input media file is identified, the entire input media file can be re-transcribed using another engine. In some embodiments, an entirely new transcription engine (not on the list of candidate transcription engine) can be selected to re-transcribe the low confidence segment.

After a new transcription engine is selected to re-transcribe the a confidence segment or the entire input media file, the input media file will have undergone at least two stages of transcription. Each subsequent transcription stage is generally more accurate than the previous transcription stage because the transcripts generated during previous stage(s) can be used as inputs to each subsequent transcription stage. In some embodiments, each subsequent transcription stage may include the use of a natural language preprocessor. As will be shown herein, processes 115, 120 and 125 may be repeated, thus the transcription process will ultimately be even more accurate each time it goes through another cycle.

Looking ahead to 135, a check may be done to determine whether the maximum allowable number of engines has been called or maximum transcription cycles have been performed. In some embodiments, the maximum allowable number of transcription engines that may be called is five, not including the initial transcription engine called in the initial transcription stage. Other maximum allowable number of transcription engines may also be considered. Once the maximum allowable number of transcription engines called is reached, a human transcription service may be used where necessary. In some embodiments, a reinforcement learning enabled transcription model can be used to transcribe the input media file (or portion of the input media file) after a certain number of transcription cycles is performed without the desired accuracy result. Back at 130, if the confidence of accuracy or accuracy value of the entire input media file or each of the transcribed portions is above a certain threshold, then the transcription process is completed. The reinforcement learning enabled transcription model will be discussed in detail starting at FIG. 5

Process 100 may also include a training process portion 150. As indicated earlier, each time a media file is received for transcription, it may also be used for training existing transcription models in the system. At 155, one or more segments of the input media along with the corresponding transcriptions may be forwarded to an accumulator, which may be a database that stores recent input media files and their corresponding transcriptions. The content of the accumulator may be joined with training data sets at 160 (described further below), which may then be used to further train one or more transcription models at 165. Thus, process 100 may continue to use real data for repeated training to improve its models.

One or more steps 110 through 165 can be considered to be part of a “conductor” which is configured to: train transcription models; select a transcription engine based on a trained model to transcribe the input media file; identify one or more segments of the transcribed media file with a low confidence of accuracy; select a new transcription engine to transcribe the one or more segments with a low confidence of accuracy; develop a new micro training model (e.g., reinforcement learning enabled transcription model) to transcribe one or more segments that cannot be transcribed to a desired level of accuracy by previously selected transcription engines (after several cycles); transcribe the one or more segments using a new micro engine, which is based on the new micro training model. In some embodiments, the new micro engine can be a reinforcement learning engine.

### Training Overview

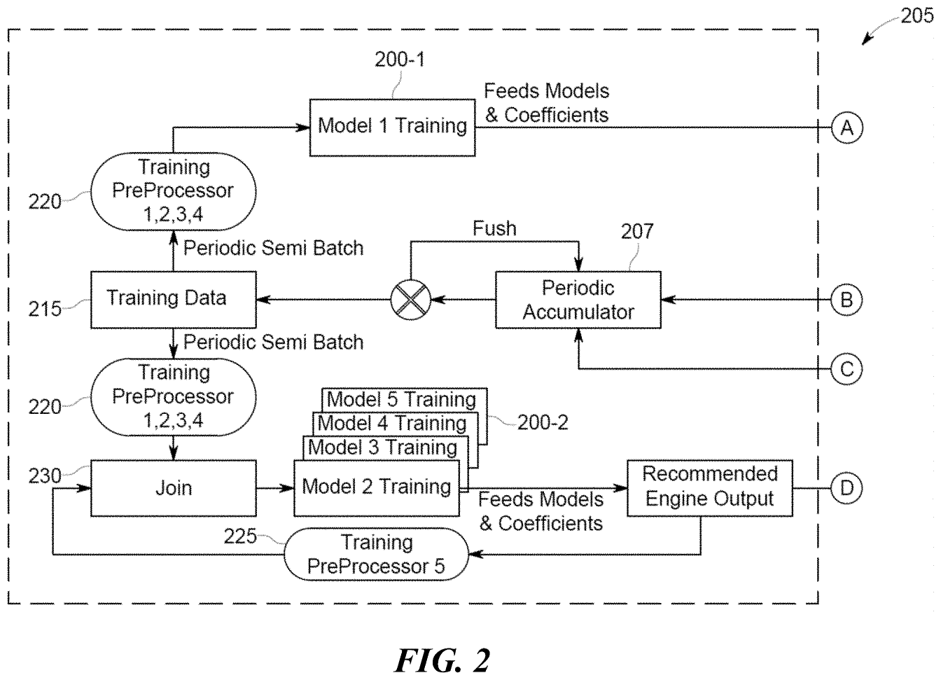

FIG. 2 illustrates an exemplary detailed process flow of training process 205 which may be similar or identical to process 150 of FIG. 1 above. In some embodiments, process 205 may include a training module 200, an accumulator 207, a training database 215, preprocessor modules 220, and preprocessor module 225. A module may include one or more software programs or may be part of a software program. In some embodiments, a module may include a hardware component. Preprocessor modules 220 may include an alphanumeric preprocessor, an audio analysis preprocessor, a continuous variable preprocessor, and a categorical preprocessor (shown as training preprocessors 1, 2, 3, 4). The database 215 may include media data sets which may include, for example, customers' ingested data, ground truth data, and training data. In some embodiments, the database 215 may be a temporal elastic database (TED).

Training module 200 may train one or more transcription models to improve an engine or to optimize the selection of engines using one or more training data sets from training database 215. Training module 200, shown with training modules 200-1 and 200-2, may train a transcription model using multiple, e.g., thousands or millions, of training data sets. Each training data set may include data from one or more media files and their corresponding features profiles and transcripts. Each training data set may be a segment of or an entire portion of a large media file. Additionally, each time a media file is ingested and transcribed, it can be added to the training data set.

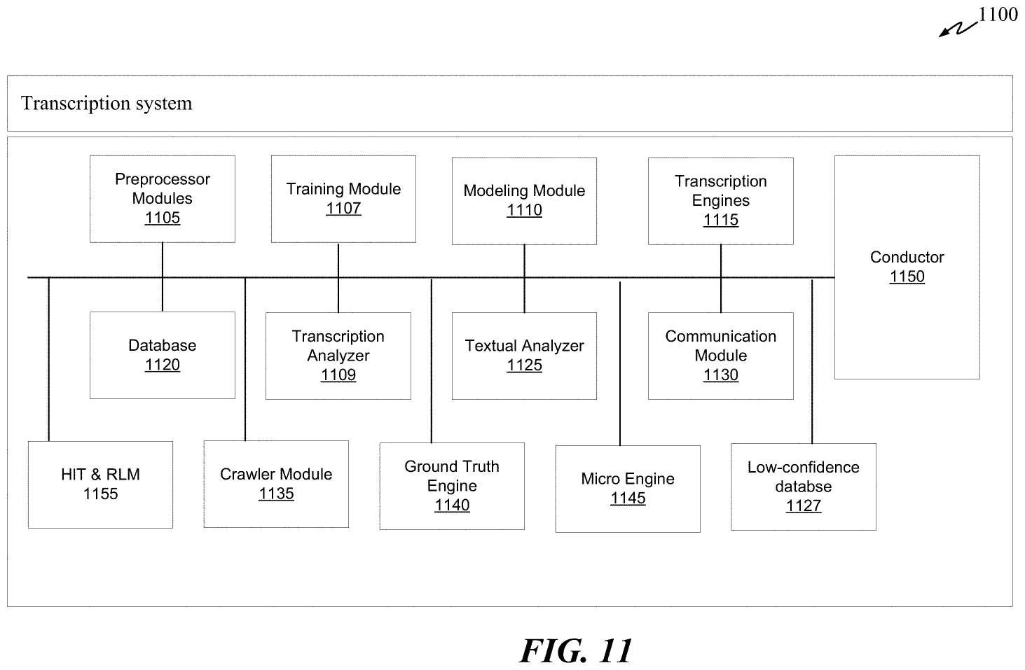

In some embodiments, a training data set may include ground truth data and the corresponding segment of media file data from which transcription has been performed. The ground truth data may be generated through an analysis process which will be described further below. In some embodiments, the analysis may be performed by one or more ground truth engines (e.g., engine 1140 in FIG. 11). In some embodiments, the analysis may be requested by the conductor to be performed externally to the conductor. In some embodiments, the external analysis may be performed by humans (also referred to as Human Intelligence Task, or HIT). In some embodiments, the Human Intelligence Task may include verifying ground truth data generated by a ground truth engine and compute accuracy of the ground truth data (or ground truth engine accuracy).

Preprocessors 220 can include, but not limited to, an alphanumeric preprocessor, an audio analysis preprocessor, a continuous variable preprocessor, a categorical preprocessor, and a topical preprocessor (for topic identification and detection). The outputs of each preprocessor may be merged to form a single merged feature profile of the input media file. In some embodiments, during a first transcription cycle (at 105), only four preprocessors are used to condition the content of the input media file. The four preprocessors used in the first transcription cycle may include an alphanumeric preprocessor, an audio analysis preprocessor, a continuous variable preprocessor, and a categorical preprocessor. In some embodiments, some of the selected preprocessors may run substantially in parallel, or in any other sequences, for example, based on one or more dependencies between the preprocessors, or any predetermined order. These advantages may include more flexibility, better efficiency, better performances, better prediction accuracy, and other advantages that will become obvious as described below. In some embodiments, the alphanumeric preprocessor may convert certain alphanumeric values to real and integer values. The audio analysis preprocessor may generate mel-frequency cepstral coefficients (MFCC) using the input media file and functions of the MFCC including mean, min, max, median, first and second derivatives, standard deviation, variance, etc. The continuous variable preprocessor can winsorize and standardize one or more continuous variables. As known in the art, winsorizing or winsorization is the transformation of statistics by limiting extreme values in the statistical data to reduce the effect of possibly spurious outlier values. The categorical preprocessor can generate frequency paretos (e.g., histogram frequency distribution) of features in the feature profile generated by the alphanumeric preprocessor. The frequency paretos may include frequency distribution histograms categorized by word frequency, and may be used in topic identification, in this way the most important features may be identified, and/or prioritized.

Prior to training a transcription model using training modules 200, data of a training data set may be pre-processed in order to condition and normalize the input data. Each preprocessor may generate a features profile of the input data (i.e., the input media file). A feature of a features profile can be added, deleted, and/or amended. For example, brackets in the metadata or the transcription data of the media file can be amended or deleted. A feature can also include relationships between words, sentiment(s) (e.g., anger, happy, sad, boredom, love, excitement), recognize speech, accent, topics (e.g., sports, documentary, romance, sci-fi, politics, legal), noise profile(s), volume profile(s), and audio analysis variables such as mel-frequency cepstral coefficients (MFCC). The number of MFCCs generated may vary. In some embodiments, the number of MFCCs generated may be, for example, between 10 and 20.

In some embodiments, training module 200-1 may train a transcription model using training data sets from existing media files and their corresponding transcription data (where available). This training data may be stored in the database (TED) 215. As noted herein, the database 215 may be periodically updated with data from recently run models via an accumulator 207. In some embodiments, if a training data set does not have a corresponding transcript, then a human transcription may be obtained to serve as the ground truth. Ground truth may refer to the accuracy of the training data set's classification. Ground truth may be represented by transcription, or segments, containing corrected words, or object features. In some embodiments, training module 200-1 only trains a transcription model using only previously generated training data set, which is independent and different from the input media file. In contrast, in some embodiments, modeling module 200-2 may train one or more transcription models using both existing media files and the most recent data (transcribed data) available for the input media file. In some embodiments, the training modules 200-1 and 200-2 may include machine learning algorithms such as, but not limited to, deep learning neural networks; gradient boosting, random forests, support vector machine learning, decision trees, variational auto-encoders (VAE), generative adversarial networks, recurrent neural networks, and convolutional neural networks (CNN), faster R-CNNs, mask R-CNNs, and SSD neural networks.

In some embodiments, input to the training module 200-2 may include outputs from a plurality of training preprocessors 220, which are combined (joined) with output from training preprocessor 225, which may be the same as preprocessor 220 plus the addition of one more preprocessors such as, but not limited to: a natural language preprocessor to determine one or more topic categories; a probability determination preprocessor to determine the predicted accuracy for each segment; and a one-hot encoding preprocessor to determine likely topic of one or more segments. Each segment may be a word or a collection of words (i.e., a sentence or a paragraph, or a fragment of a sentence).

As noted above, accumulator 207 may collect data from recently run models and store it until a sufficient amount of data is collected. Once a sufficient amount of data is stored, it can be ingested into database 215 and used for training of future transcription models. In some embodiments, data from the accumulator 207 is combined with existing training data in database 215 at a determined periodic time, for example, once a week. This may be referred to as a flush procedure, where data from the accumulator 207 is flushed into database 215. Once flushed, all data in the accumulator 207 may be cleared to start anew.

In some circumstances, even after the training process described above, the best transcription engine selected to transcribe a media file may still result in one or more transcribed potions having errors. These errors are sometime persistent because after a number of iterations of transcribing using selected transcription engines, the errors still exist.

As disclosed in U.S. application Ser. No. 16/052,459, which is incorporated herein, the identification of transcribed portions that contain persistent errors may be done by determining the confidence value (or confidence of accuracy value) for each transcribed portion and/or performing textual analysis on each transcribed portion. The confidence of accuracy for a transcribed portion can be determined based at least in part on transcription metadata of the transcribed portion, which can be provided by a transcription engine or can be locally generated based on at least words analytics on the transcribed portion and metadata of the input media file. In some embodiments, transcription metadata can include a confidence value indicating the level of confidence the transcription engine assigned to each transcribed portion. The conductor can normalize the confidence value received from various transcription engines in order to compensate for the different confidence scales used by the various transcription engines. In some embodiments, the confidence of accuracy of a transcribed portion is based at least in part on the normalized confidence value. Next, the conductor can identify low confidence segments, using a transcription analyzer (e.g., transcription analyzer 1109 in FIG. 11). Low confidence segments are segments of the input media file having corresponding transcribed portions with a level of confidence of accuracy below a predetermined minimum accuracy threshold.

Once the transcription analyzer identifies low confidence segments, the conductor may select another transcription engine with the best expected improvement to transcribe the low confidence segments. If after a predetermined number of iterations of selecting and running different transcription engines and the level of confidence of accuracy is still below the minimum accuracy threshold, the conductor may store the identified transcribe portions and corresponding segments in the database (e.g., database 1120 or low confidence database 1127 in FIG. 11) and request further analysis on the transcribed portions. As described herein, the requested analysis on a transcribed portion may return an analysis result that has a revised-transcription portion of the transcribed portion, which comprises one or more parts of the transcribed potion that have been revised. In some embodiments, the one or more parts may comprise ground truth data that has been labelled. The ground truth data may then be stored in the database together with the corresponding segments.

The identification of transcribed portions with low confidence segments can also be done by performing textual analysis on each transcribed portion. Textual analysis can include one or more of, but not limited to, a contextual analysis, a grammatical analysis, a lexical analysis, a topical analysis, a word composition analysis (e.g., nouns, verbs, adjectives, preposition), and a sentiment analysis. If the results from a textual analyzer (see item 1125 of FIG. 11) indicate that there is a high probability that transcribed portion is incorrect. For example, if results from a contextual analyzer (of the textual analyzer) indicate that one or more words in the transcribed portion is out of context as compared to the entire transcribed portion and/or a portion or the entire input media file, then the transcribed portion can be flagged as having error or persistent error, and for further analysis. In another example, if results from a grammatical analyzer (of the textual analyzer) indicate that the transcribed portion is grammatically incorrect, then the transcribed portion can be flagged for further analysis. In yet another example, if results from a lexical analyzer (of the textual analyzer) indicate that one or more characters are out of place, then the transcribed portion may be flagged for further analysis.

In yet another example, if results from a topical analyzer (of the textual analyzer) indicate that the transcribed portion is likely to be incorrect in view of the topic of the transcribed portion or the input media file, then the transcribed portion may be flagged. In this example, the topic of the input media file can be sports and the transcribed portion in question is “Roth less burger.” In this case, the topical analyzer can flag the transcribed portion because the likely correct spelling, considering the topic of the input media file is sports, is “Roethlisberger.” In yet another example, if results from a word composition analyzer (of the textual analyzer) indicate that the transcribed portion contains three consecutive verbs, then the transcribed portion may be flagged.

In some embodiments, the textual analysis can be performed by a textual analyzer, which can include a contextual analyzer, a grammatical analyzer, a lexical analyzer, a topical analyzer, a word composition analyzer, and a sentiment analyzer. The textual analyzer can include one or more machine learning algorithms configured to learn and perform contextual, grammatical, lexical, topical, composition, and/or sentiment analyses.

In some embodiments, outputs from a transcription engine can include a confidence indicator, or value, or score associated with each word in the transcription. The confidence score may reflect the transcription engine's own metrics of how accurate each transcribed word is. Accordingly, in some embodiments, the conductor can normalize confidence scores across various engines using, for example, linear regression. The normalization process can be performed in advance using one or more training data sets with ground truth transcriptions. Once normalized, the confidence score of each transcribed portion can be used to determine whether each transcribed portion is sufficiently accurate or is flagged for further analysis.

In some embodiments, after identifying a transcribed portion for having persistent errors, and before requesting analysis on the transcribed portion, the conductor may send the audio segment corresponding to the transcribed portion with persistent error(s) to a successive plurality of transcription engines, and receive successive transcribed portions from the successive plurality of transcription engines. The conductor then replaces the transcribed portion with persistent error(s) with one of the received successive transcribed portions based on the confidence of accuracy value of each successive transcribed portion. In some embodiments, the successive transcribed portion selected to replace the transcribed portion with persistent errors may have the best confidence value among the received successive transcribed portions. If the confidence value of the selected transcribed portion is still below the predetermined confidence threshold, the conductor can request a reinforcement learning enabled transcription model to re-transcribe the audio segment.

Each transcribed portion has a corresponding segment of the input media file, which can be determined using the transcription metadata. For example, a transcribed portion can have a start and end time with respect to the playtime of the input media file. The start and end time or the positional data can be included in the transcription metadata. Using the transcription metadata, each transcribed portion can be associated with a particular segment of the input media file.

### Virtuous Cycle

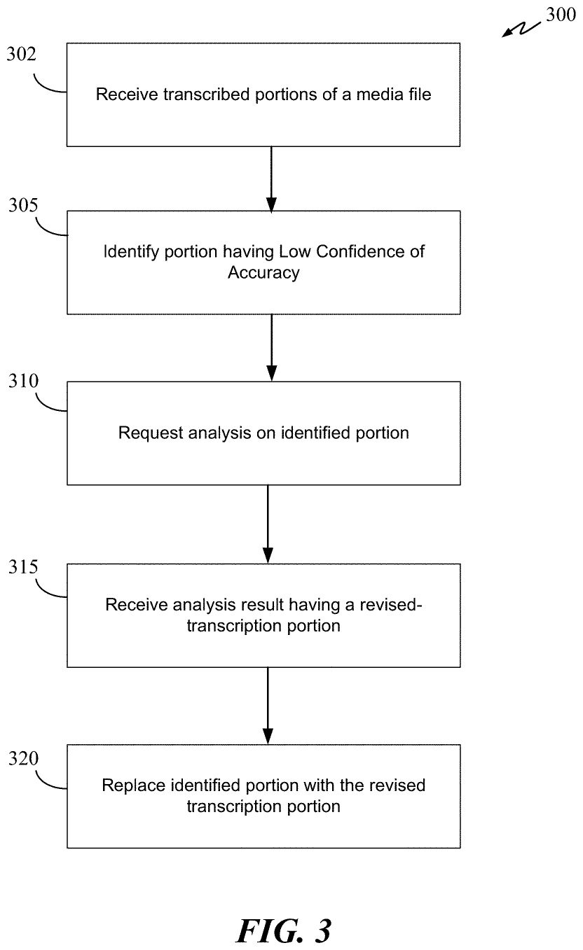

FIG. 3 illustrates a process 300 in which the conductor can implement to improve transcription models and resulting transcriptions in accordance with some embodiments of the present disclosure. On a high level, process 300 is a virtuous cycle-transcription process that uses a forced reanalysis or an active-corrective action (e.g., modifying the audio waveform using reinforcement learning) on persistently low confidence transcribed portions, which have corresponding audio segments of the input media file. A forced reanalysis of persistently low confidence segments can include using HIT services to obtain ground truth transcription or to enhance transcription metadata that can help subsequent transcription cycle(s). An active-corrective action can include a process that generates a reward function based on characteristics of an open transcription engine. The reward function is then used to modify phoneme sequences of the low confidence segment. The modified phoneme sequences are then converted back into an audio waveform for re-transcription.

Process 300 starts at 302 where the conductor may receive, from a first transcription engine, one or more transcribed portions of a media file. In some embodiments, the first transcription engine may be selected from a list of ranked engines as described in process 100 above.

At 305, a low-confidence portion from the one or more received transcribed portions is identified. A low-confidence portion is a portion that has a low confidence of accuracy. In some embodiments, a textual analyzer (e.g., textual analyzer 1125) can be used to identify low-confidence portions from the one or more transcribed portions. For example, the textual analyzer can identify a first transcribed portion to have a confidence of accuracy value below a predetermined threshold (e.g., 80% probability of accuracy). The textual analyzer can also use a probabilistic language model to identify and highlight portions of interest. The probabilistic language model can assign a probability to each portions of the transcription. In some embodiments, portions that are more likely to have been erroneously transcribed segments are given a higher probability of error. In this way, more inaccurately transcribed segments can be identified (e.g., highlighted). The textual analyzer can also be configured to use nonlinear auto-regressive algorithms to identify transcribed portions that are likely transcribed erroneously.

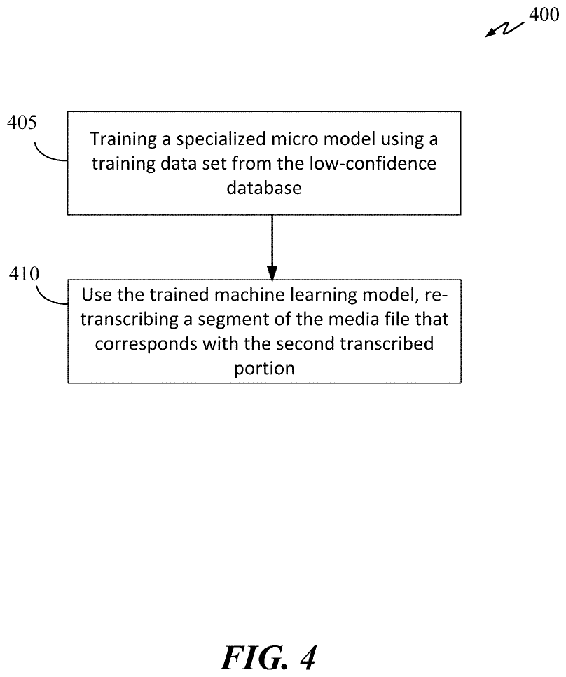

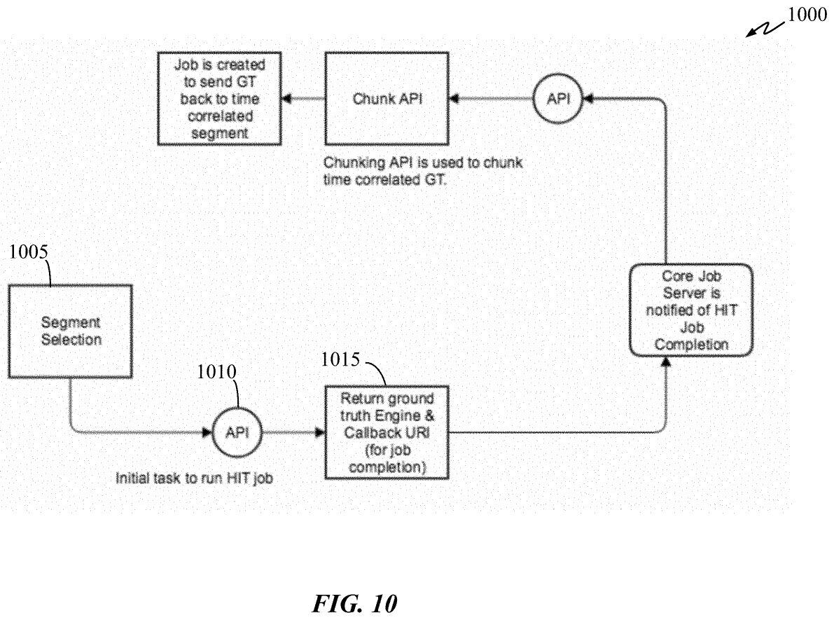

At 310, if the confidence value of the first transcribed portion is below the predetermined accuracy threshold, the conductor can request the segment of the input media corresponding to the first transcribed portion to be reanalyzed by a HIT service, a specialized micro engine (see FIG. 4), and/or by a reinforcement learning enabled transcription model (see FIG. 5). In some embodiments, if the confidence value of the first transcribed portion is below the predetermined accuracy threshold even after several transcription cycles (e.g., 5 transcription attempts), the conductor can request the segment of the input media to be reanalyzed by a specialized micro engine (see at least FIG. 4), and/or by a reinforcement learning enabled transcription model (see at least FIG. 5), and/or a HIT service (see at least FIG. 10).

A user may select the length of the low confidence segment for further analysis on the first transcribed portion. The length of the first transcribed portion requested for analysis may be a predetermined length or may be adjustable in real-time. For example, a predetermined length of an audio portion may be 10 seconds. In some embodiments, a user or the conductor may select and/or adjust the accuracy threshold in real-time. The length can also be measured with the number of spoken words in the audio segment.

At 315, the conductor may receive an analysis result or a revised-transcription from the HIT service or the reinforcement learning enabled transcription model. The HIT service can identify one or more transcription errors in the first transcribed portion. For example, the HIT service can identify additional errors that are not previously detected. The HIT service may then correct the identified errors, for example, by replacing the erroneously transcribed words with the correct words.

When requesting further analysis (at 310) to be performed by the HIT service, the conductor may send the transcribed portion of low confidence along with the corresponding media file segment. In some embodiments, the conductor, at 310, may also send the corresponding media segment to the ground truth engine or to the reinforcement learning enabled transcription model.

In some embodiments, the HIT service may include verifying ground truth data or transcription generated by the reinforcement learning enabled transcription model. The conductor may use this accuracy data to create a model which can be used to estimate accuracy from confidence scores in the transcribed portion of low confidence sent to HIT.

In some embodiments, the reinforcement learning enabled transcription model can be used to automatically re-transcribe the low confidence segment using reinforcement learning techniques. The revised-transcription can also be received from a specialized micro-engine that was specifically trained with audio segments with low transcription accuracy and corresponding ground truth data of the audio segments.

The ground truth engine and/or the reinforcement learning enabled transcription model (engine) may be external to the conductor. The conductor may communicate with the ground truth engine and/or the reinforcement learning enabled transcription engine via an application program interface (API). The conductor may send data to the ground truth engine and/or the reinforcement learning enabled transcription engine via live-streaming. The conductor may also send data to the ground truth engine and/or the reinforcement learning enabled transcription engine in batch mode. Data exchanged between the conductor and externally located engines may be encrypted.

At 320, process 300 can replace the first transcribed portion with the revised-transcription portion provided by one of the HIT service, the specialized micro engine, and the reinforcement learning enabled transcription model. The revised-transcription portion can have one or more portions having errors that have been corrected. revised-transcription portion can include enhanced metadata such as, but not limited to, a topic of segment and labels of objects.

FIG. 4 illustrates a process 400 for training a specialized micro engine (e.g., neural network) using a training dataset having previously identified (at 305) low confidence segments and for transcribing a newly identified low confidence segment using the trained specialized engine in accordance with some embodiments of the present disclosure. At 405, the specialized engine is trained using a training data set from the low-confidence database, which contains previously identified low confidence segments and their corresponding ground truth data. Once trained, the specialized engine can be used to transcribe low confidence segments having similar audio features. At 410, the conductor may request the trained specialized micro engine to re-transcribe any low confidence segments identified at 305. This can be done in place of and/or in parallel with the request for re-analysis (e.g., re-transcription) by the HIT service and/or by the reinforcement learning enabled transcription model.

### Reinforcement Learning

FIG. 5 is a diagram illustrating various components of the reinforcement learning transcription (RLT) system 500 in accordance with some embodiments of the disclosure. RLT system 500 includes an instrument module 510, a transcription engine 520, a classifier 525, a cumulant module 535, and a reinforcement learning (RL) module 540.

Instrument module 510 can be a collection of one or more modules such as a phoneme construction or reconstruction module 515 (depending upon the input source) and a transfer function module 518. Phoneme construction module 515 can include phoneme recognition algorithms to construct phoneme sequences from audio data of a media file (input data) or from audio parameters of a reward function, which is generated by reinforcement learning module 540. Once the phoneme sequences are generated, they serve as inputs to transfer function module 518, which generates a new waveform based on the input data (or media file) and/or the phoneme sequences generated by phoneme construction module 515. The new waveform can represent a portion or the entirety of the audio data of the input data, depending upon the current stage of the iterative reinforcement learning process. It is noted that a media file can be an audio file, a video file, or a combination thereof.

Phoneme construction module 515 can recognize individual phoneme and construct a sequence of phonemes for each word in the input data. A phoneme is a unit of sound that carries a semantic value. For example, phonemes characterize by the letters “ae” and “eh” are similar but carry with them very different meanings in words that carry them—words such as “bat” and “bet”, which have very different meaning. A collection or sequence of phonemes distinguish a word from another for a particular dialect. Most English dialects have 44 phonemes. In some embodiments, phoneme construction module 515 can use adaptive wavelet transform, discrete wavelet transform, continuous wavelet transform, or a combination thereof to construct phoneme sequences of the input data. Stated differently, phoneme construction module 515 can separate the input signal into time frequency wavelets corresponding to phonemes sequences of words, which are provided as input for transfer function module 518. It should be noted that other methods of phoneme construction can be used such using Fourier analysis, hidden Markov model, or discriminative kernel-based phoneme sequence. In some embodiments, phoneme construction module 515 can generate Harr wavelets, Daubechies wavelets, and/or bi-orthogonal wavelets.

In some embodiments, transfer function module 518 models a microphone transfer function, an amplifier transfer function, and a sampler transfer function of an ideal microphone.

Transfer function module 518 can include a microphone module, an amplifier module, and a sampler module, each having its own unique transfer function to generate audio waveform from one or more phoneme sequences. Depending upon the phonemes sequence and/or the actions to be taken by instrument module 510 (as dictated by the reward function), each phonemes sequence may be individually processed by a microphone module, an amplitude module, a sampler module, or a combination thereof. For example, the reward function may dictate an action that includes modifying the bass and the average amplitude of a waveform, but not the treble or the deviation of the waveform. This action may require the services of the amplitude module and the sampler module, but not the microphone module, for example. Transfer function module 518 may aggregate the output of each transfer function (e.g., microphone, amplifier, and sampler) to form a single output waveform.

The output waveform is then processed by a transcription engine 520, which can be a local or external (third-party) transcription engines such as the Nuance engine, the Genesys engine, and the Dragon engine. Transcription engine 520 can be a collection of transcription engines. However, system 500 can select one transcription engine based on a permission setting (e.g., client's subscription level), for example, to perform reinforcement learning, which allows system 500 to dynamically learn the internal characteristics of the selected transcription engine.

The output of (the selected) transcription engine 520 can include transcribed words or text of the audio data portion of the input data and a confidence value of each of the transcribed words. The confidence value indicates the level of confidence that the transcribed word is accurate. In some embodiments, the confidence values can be standardized against confidence values of an ideal waveform.

The objective of transcription accuracy classifier 525 is to determine whether each of the transcribed words meets a certain accuracy threshold. If the accuracy threshold is met, then accuracy classifier 525 can place a transcribed word, along with its confidence value, in a high-accuracy database 530. The accuracy threshold can be a predetermined value such as 80% level of confidence, for example. For words with a low confidence value, accuracy classifier 525 can place them in a low-accuracy database, which will serve as inputs to cumulant module 535. A low-accuracy threshold can be a confidence value of 60% or less, for example.

As mentioned, accuracy classifier 525 can classify each transcribed word using a confidence value provided by transcription engine 520. In some embodiments, accuracy classifier 525 can classify each transcribed word using one or more combinations of classifying parameters such as confidence values, ground truth data, wavelet transform coefficients, the entropy of the signal, and the energy distribution of the signal. For example, a waveform of a word can have a very intense energy distribution. This can indicate the present of very high noise. In some embodiments, accuracy classifier 525 can classify a word into a high or a low accuracy category based on one or more of the classifying parameters. For example, accuracy classifier 525 can classify a word into a high or a low accuracy category based on a combination of confidence value and the entropy of the signal.

In some embodiments, accuracy classifier 525 can also weight each of the classifying parameters in making the determination of high and low accuracy for each transcribed word. For example, the entropy of the signal can have the highest weight, the second highest weight can be the confidence value, and the lowest weight can be the transform coefficients. Alternatively, one or more of these parameters can have the same weight.

The output of transcription engine 520 can include metadata related to each transcribed word. The metadata can include location identifying information of a transcribed word such as, but not limited to, the start and stop time of the transcribed word within the media file. In this way, a portion or the entire transcript can be reconstructed using stored transcribed words from high-accuracy database 530 after a certain number iterations. The metadata can also be used by cumulant module 535 to create a string of cumulants (words) around a low-accuracy word identified by classifier 525. Cumulant module 535 can create a string of cumulants consisting of 2-9 words appearing before and after the low-accuracy word. In some embodiments, cumulant module 535 can create a string of cumulants consisting of 5 words ahead and 3 words after a low-accuracy word. The string of cumulants will then serve as input to Reinforcement learning module 540.

In some embodiments, Reinforcement learning module 540 can be a dynamic programming module that uses backward induction to solve an optimization equation involving the Bellman equation as shown below.

$$( y , t ) = {max}_{u} \{ {\sum }_{{y}^{′}} {P}_{{yy}^{′}} ( {u}_{t} ) \cdot V ( {y}^{′} , t + 1 ) - L ( y , u , t ) \} \qquad Equation 1$$

Reinforcement learning module 540 uses dynamic programming to transform a complex problem into a group of simpler sub-problems. V is a reward function based on a state at time t. The goal is to maximize the reward at each state, which is y. The state y can be defined as wavelet transforms of phonemes over a finite set S, which is equal to {y(1), y(2), . . . y(n)}. In equation 1, the possibility function Pyy′ is trained to capture the dynamic characteristics of transcription engine 520. This means that Pyy′ does not depend on individual word.

The variable u is an action vector applied on the features of the phoneme wavelet transforms. As previously mentioned, phoneme wavelets can be generated using adaptive wavelet transform, discrete wavelet transform, continuous wavelet transform, or a combination thereof. The features of the phoneme wavelet can include audio features such as, but not limited to, treble, bass, average amplitude, deviation, frequency discriminant (which is the product of all the frequencies in the phoneme divided by the by the sum of frequencies), the coefficient of amplitude modulation (which constrained action between −1 and 1), the coefficient of phase modulation (constrained between 0 and 1), and the like. It should be noted that the above list of audio features is not exhaustive and that other features such as, but not limited to, the energy distribution (spectrum), frequency, pitch, spectral flax, and mel frequency cepstral coefficients (MFCC) are contemplated and are within the scope of this disclosure.

As shown in equation 1, Reinforcement learning module 540 uses a dynamic approximation function that includes the Dempster Shafer possibility matrix, which is denoted as Pyy′. This is one of the unique aspects of Reinforcement learning module 540 as conventional dynamic approximation function uses stochastic (Markov) matrix, which is singleton based. In other words, conventional dynamic programming with the Markov matrix uses a point-based probability matrix with each row adding up to 1. In contrast, the Dempster Shafer possibility function used by Reinforcement learning module 540 is set-based, meaning variables of a single row in a possibility matrix can have set values that do not have to add up to 1. In the possibility matrix, a belief (possibility) value may be assigned to sets of potentials without having to distribute the mass among the individual potentials in the set (to equal to 1). In this way, the dynamic approximation using a Dempster Shafer possibility matrix is semantically richer than the dynamic approximation using a point-based probability matrix.

In some embodiments, Reinforcement learning module 540 can use backward induction to find the reward function, which can also be represented as shown in equation 2.

$${max}_{{u}_{t} , {u}_{t + 1} , … , {u}_{t + N - 1} ,} E ( - {\sum }_{k = 0}^{N - 1} L ( y , u , t + k ) ) \qquad Equation 2$$

To find the maximize the reward function V(y,t), Reinforcement learning module 540 can use the principle of backward induction by first determining L. In equation 2, N is the number of iterations, which is selected such that the reward function would yield a desired level of accuracy in the final transcription of a waveform created using the reward function. In some embodiments, N can be determined using empirical data or based on a value of a previous run of transcription engine 520. K is the number of stages in the permutation.

L is the general measure of uncertainty in the engine (e.g., open transcription engine), which can be the Shannon entropy of transcription engine 520 computed at the Shannon channel. In some embodiments, L is represented by equation 3, as shown below.

L(y, u, t)=−log( [symbol] ·Cₜ+Cₜ·yₜ^{T}·Wₜ⁽¹⁾·uₜ+(1−Cₜ)·yₜ^{T}·Wₜ⁽²⁾·uₜ) Equation 3

Reinforcement learning module 540 can learn the characteristics of transcription engine 520 by learning the variables [symbol] and W. In some embodiments, [symbol] and W can be determined using the recursive least square method. The variable [symbol] is a positive coefficient.

The variable Ct is the observed grade after processing the action ut−1 at previous time t−1, wherein 0<Ct≤1. For example, Ct can be the normalized confidence generated by transcription engine 520. Next, equation 1 can be re-written in matrix form as:

$$[ \begin{matrix}V ( {y}^{( 1 )} , t ) \\ V ( {y}^{( 2 )} , t ) \\ ⋮ \\ V ( {y}^{( n )} , t )\end{matrix} ] = max \{ [ \begin{matrix}{P}_{{y}^{( 1 )} {y}^{( 1 )}} ( {u}_{t , 1} ) & … & {P}_{{y}^{( 1 )} {y}^{( n )}} ( {u}_{t , 1} ) \\ ⋮ & ⋱ & ⋮ \\ {P}_{{y}^{( n )} {y}^{( 1 )}} ( {u}_{t , n} ) & … & {P}_{{y}^{( n )} {y}^{( n )}} ( {u}_{t , n} )\end{matrix} ] \cdot [ \begin{matrix}V ( {y}^{( 1 )} , t + 1 ) \\ V ( {y}^{( 2 )} , t + 1 ) \\ ⋮ \\ V ( {y}^{( n )} , t + 1 )\end{matrix} ] + [ \begin{matrix}L ( {y}^{( 1 )} , {u}_{t , 1} , t ) \\ L ( {y}^{( 2 )} , {u}_{t , 2} , t ) \\ ⋮ \\ L ( {y}^{( n )} , {u}_{t , n} , t )\end{matrix} ] \}$$

Once the coefficients of L are learned, the possibility matrix and the reward function can be derived using backward induction rather than going through all of the iterations of the possibility function. Reinforcement learning module 540 then provides the generated reward function based on the actions vector (u) to instrument module 510, which will reconstruct a one or more new phonemes sequences based on the generated reward function. The new phonemes sequence then goes through one or more transfer functions of transfer function module 518, which generates a new waveform from the new phonemes sequence. Next, the new waveform is fed into transcription engine 520, which produces a revised transcription. If the revised transcription is above a predetermined accuracy threshold, the transcribed word is stored in database 530. If the revised transcription is below a predetermined accuracy threshold, the low-accuracy word goes back to cumulant module 535 and the cycle continues. Reinforcement learning module 540 can repeat this cycle until each string of cumulants has gone through a sufficient number of iterations to achieve a desired level of accuracy or a maximum number of iterations has been performed.

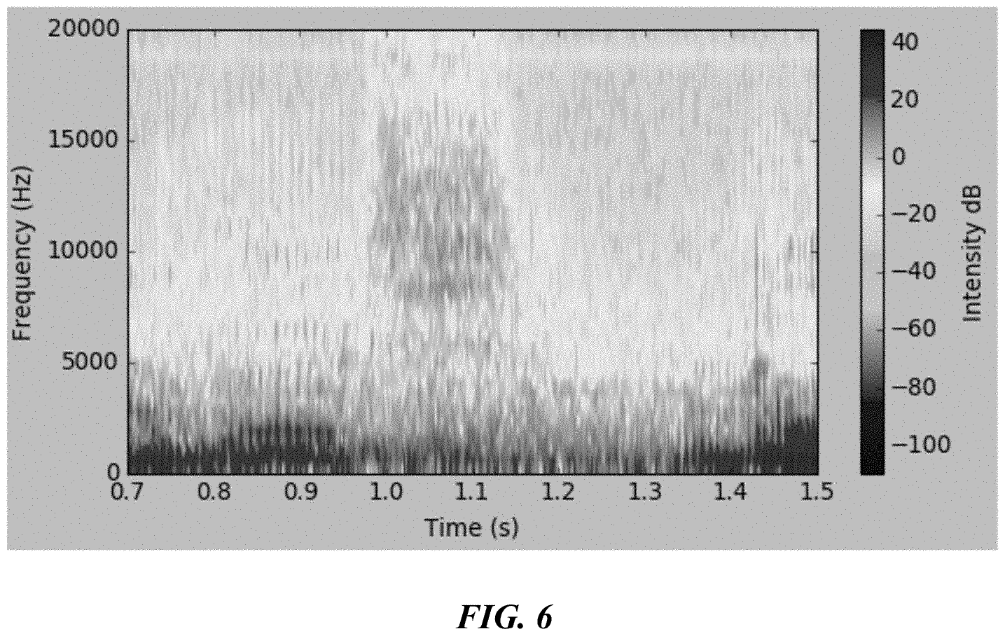

FIG. 6 illustrates an exemplary time frequency decomposition of a signal associated with a poorly transcribed word. As shown, the signal has a very strong energy intensity over a wide range of frequency between the time range 1.0 and 1.2. This can overwhelm the energy profile normally associated with a particular phoneme sequence.

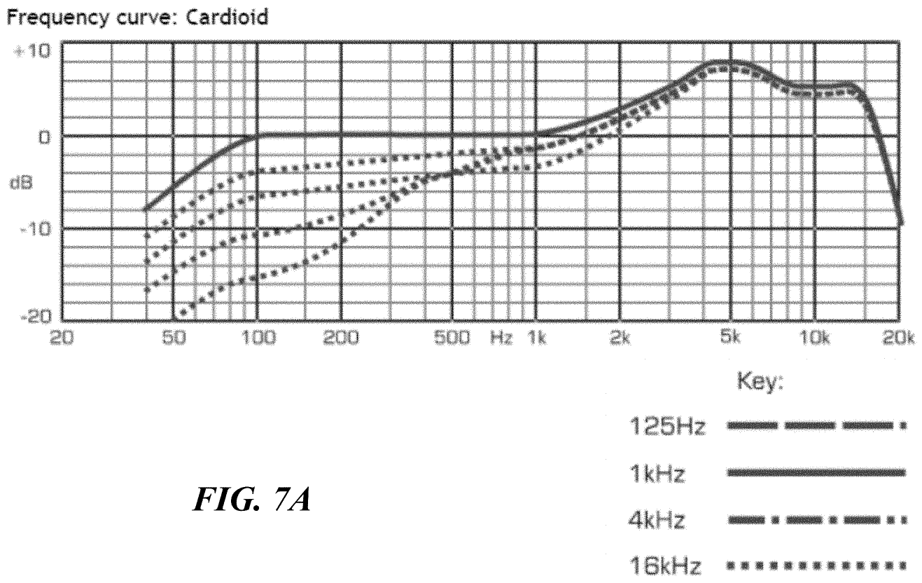

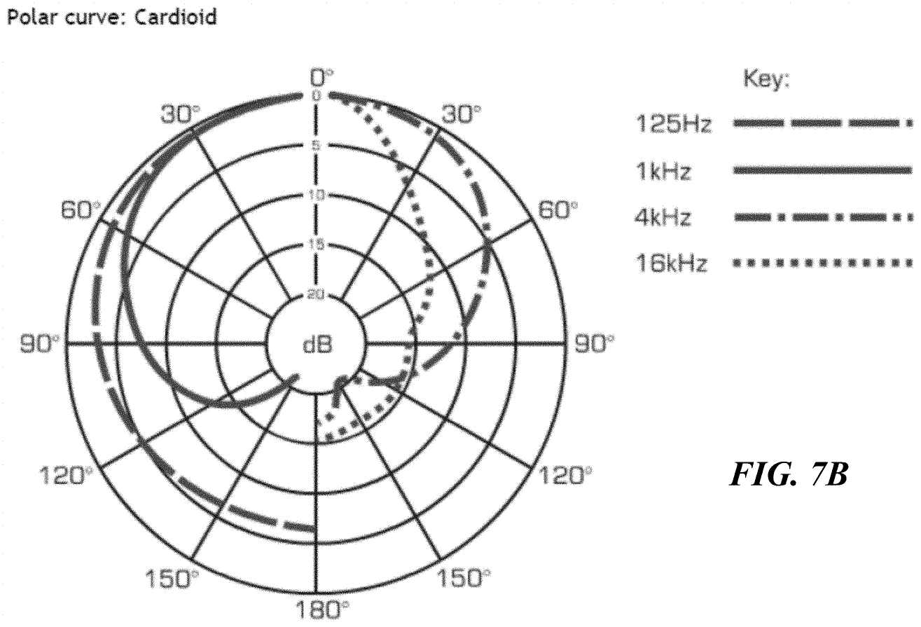

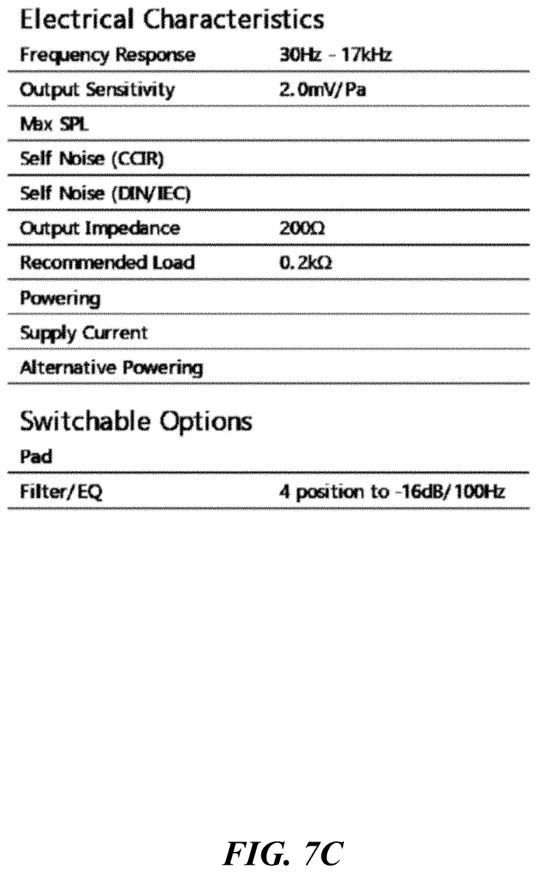

FIG. 7A illustrates the frequency responses that can be exhibited by a cardioid microphone module implemented by transfer function module 518. The microphone module of transfer function module 518 can have one or more frequency response profiles (e.g., as shown in the legend: 125 Hz, 1 k Hz, 4 k Hz, and 16 k Hz). As shown, for a 1K Hz reference tone, the microphone module can have a flat frequency response between 100-1000 Hz, and a significant roll off at less than 100 Hz and also at greater than 16 k Hz. The microphone module also exhibits a wide range of frequency sensitivity between the frequency range of 2 k-16 k Hz.

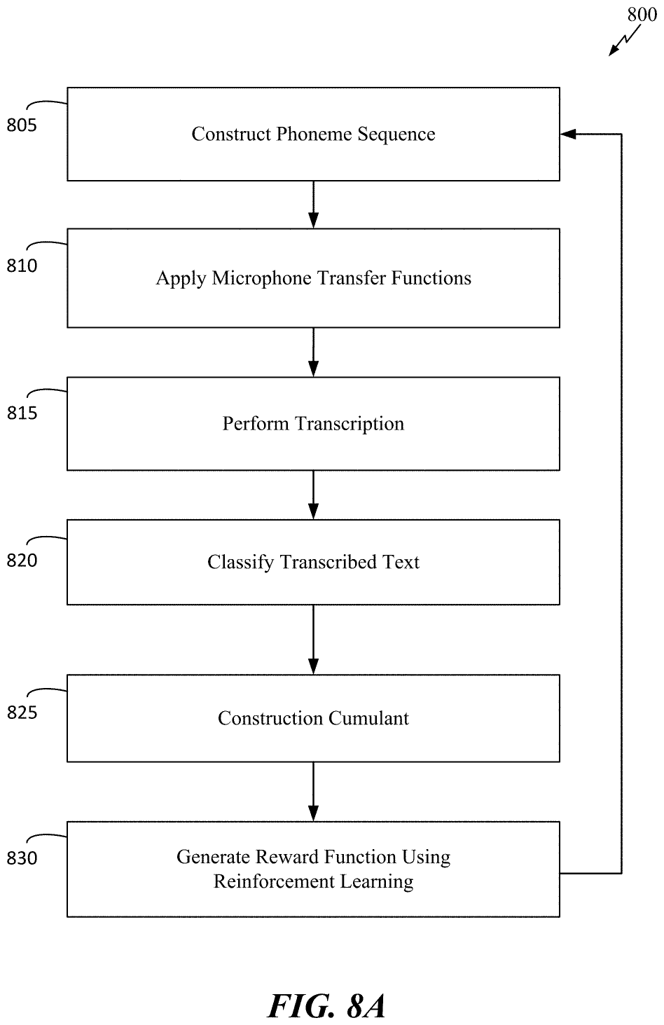

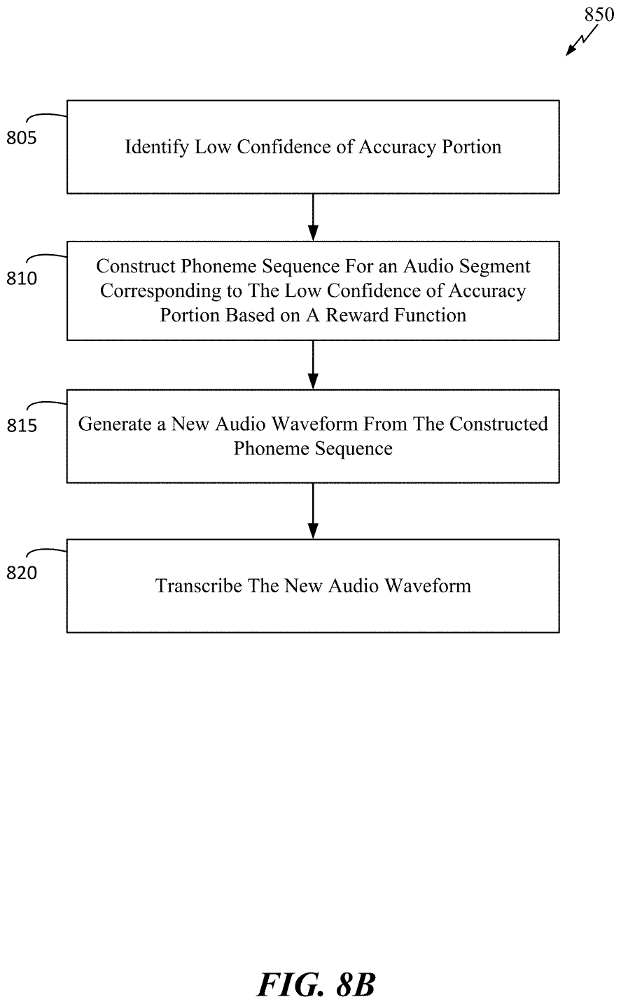

FIG. 7B illustrates the polar response of microphone module at certain frequency profiles. In some embodiment, the microphone module models a cardioid microphone, which is sensitive in mainly the forward direction of the microphone. This means sound or signal coming in at the rear of the microphone are largely ignored. In some embodiments, microphone module can model an omnidirectional or a FIG. 8 microphone.

FIG. 7C illustrates the electrical characteristics of the microphone module in accordance with some embodiments of the present disclosure. As illustrated, the microphone module can have a frequency response between 30 Hz-17 k Hz, an output impedance of 200Ω, and a recommended load of 0.2 kΩ.

FIG. 8A illustrates a reinforcement learning (RL) process 800 in accordance with some embodiments of the present disclosure. RL process 800 starts at 805 where input data from a media file or from reinforcement learning module 540 are ingested and a phoneme sequence of each word in the input data are generated. The phoneme sequence(s) can be generated using various known methods such as, but not limited to, discrete wavelet transform and continuous wavelet transform. At 810, the phoneme sequence(s) is applied to one or more transfer functions such as a microphone transfer function, an amplifier transfer function, and a sampler transfer function. Each phoneme sequence can have a certain defining characteristic that requires the phoneme sequence to be processed by a particular transfer function. Alternatively, the phoneme sequence can be processed by multiple transfer functions. For example, the reward function may dictate an action that includes modifying the average amplitude and the treble of a waveform. This reward action may require the phoneme sequence to be processed by the amplitude and microphone modules, for example. Additionally, at 810, transfer function module 518 may aggregate the output of one or more transfer functions to form a single output waveform.

At 815, the output waveform is feed into transcription engine 520, which generates a transcription of the output waveform. At 820, each word of the generated transcription is classified by accuracy classifier 125 into two categories: good (or sufficiently good) and bad. In some embodiments, each word is classified based on its confidence value. Alternatively, one or more classifying parameters can be used to classify each word. The classifying parameters can be a confidence value, ground truth comparison data, wavelet transform coefficients, the entropy of the signal, and the energy distribution of the signal. Words that meet a certain accuracy threshold can be stored in a high-accuracy database. Words that do not meet the accuracy threshold are placed into a cumulant or a low-accuracy database.

At 825, a string of cumulants is generated using one or more words in the low-accuracy database. A string of cumulants can consist of a low-accuracy word and 2-9 words preceding and following the low-accuracy word. For example, if a low-accuracy word is “cat”, the string of cumulants for “cat” can be “the dog chased the cat up the tree.”

At 830, a reward function is generated based an action vector of the Bellman' s equation. In some embodiments, the action vector can modify features of the phoneme wavelet by modifying the audio features of the waveform. The audio features can include, but not limited to, the following audio characteristics: treble, bass, average amplitude, deviation, spectral flax, MFCC, frequency discriminant (which is the product of all the frequencies in the phoneme divided by the by the sum of frequencies), the coefficient of amplitude modulation (which constrained action between −1 and 1), and the coefficient of phase modulation (constrained between 0 and 1), etc.

Further, at 830, the generated reward function is used as feedback of the reinforcement learning system, which is used to generate new phoneme sequences that are fed into transcription engine 520, which produces a revised transcription. If the revised transcription is above a predetermined accuracy threshold, the transcribed word is stored in database 530. If the revised transcription is below a predetermined accuracy threshold, the low-accuracy word goes back to cumulant module 135 and the cycle continues. Reinforcement learning module 540 can repeat this cycle (processes 805 through 830) until each strings of cumulants has gone through a sufficient number of iterations to achieve a desired level of accuracy or a maximum number of iterations has been performed.

FIG. 8B illustrates a process 850 for transcribing a low confidence of accuracy transcription portion in accordance with some embodiments of the present disclosure. The low confidence of accuracy portion can be part of a transcription result generated by, for example, process 100 at 125 or process 300 at 305. At 810, one or more phoneme sequences are constructed for the audio segment corresponding to the identified low confidence of accuracy portion. At 815, a new audio waveform is generated for the one or more constructed phoneme sequences, using one or more transfer functions. At 820, the generated audio waveform is used as input for a transcription engine, which generates a new transcription for the audio segment corresponding to the identified low confidence of accuracy portion.

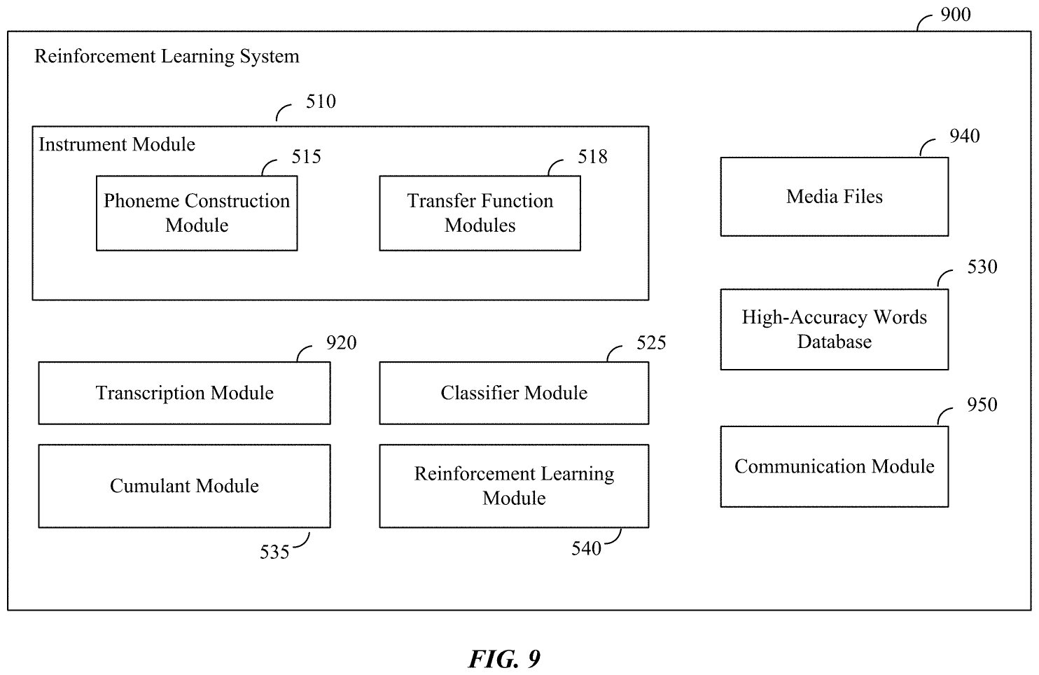

FIG. 9 illustrate a system diagram for a reinforcement learning system 900 in accordance with some embodiments of the disclosure. System 900 can include an instrument module 510, which comprises a phoneme construction module 515 and a transfer function module 518. System 900 can further include classifier module 525, cumulant module 535, reinforcement learning module 540, high-accuracy words database 530, a transcription module 920, a media file database 940, and a communication module 950. System 900 may reside on a local server or may be distributedly located (e.g., locally and remotely located). For example, one or more modules (e.g., 515, 540) of system 900 may be distributedly located at various locations throughout a network. Each component or module of system 900 may communicate with each other and with external entities via communication module 950. Each component or module of system 900 may include its own sub-communication module to further facilitate with intra and/or inter-system communication.

Phoneme construction module 515 includes algorithms and instructions, when execute by a processor, causes the processor to perform the functions and features as describe above with respect to the phoneme construction module 515 as described above and with respect, but not limited, to processes 500 and 800. In some embodiments, phoneme construction module 515 may use adaptive wavelet transformation, discrete wavelet transformation, continuous wavelet transformation, or a combination thereof.

Transfer function module 518 can includes a microphone, an amplifier, and a sampler transfer function. Each of these transfer functions algorithms and instructions, when execute by a processor, causes the processor to perform the functions and features as describe above with respect to transfer function module 518 of FIG. 5 as described above and with respect, but not limited, to process 800 (e.g., box 810).

Classifier module 525 includes algorithms and instructions, when execute by a processor, causes the processor to perform the functions and features as describe above with respect to the accuracy classifier 525 of FIG. 5 and with respect, but not limited, to process 800 (e.g., box 820).

Cumulant module 535 includes algorithms and instructions, when execute by a processor, causes the processor to perform the functions and features as describe above with respect to the cumulant 535 of FIG. 5 as described above and with respect, but not limited, to process 800 (e.g., including box 825).

Reinforcement learning module 540 includes algorithms and instructions, when execute by a processor, causes the processor to perform the functions and features as describe above with respect to the reinforcement learning module 540 of FIG. 5 as described above and with respect, but not limited, to process 800.

Rather than using reinforcement learning system 500 to re-transcribe a low confidence segment, a HIT service can be requested to reanalyze the low confidence segment. FIG. 10 illustrates a HIT service process 1000 which the conductor can implement to improve transcription models in accordance with some embodiments of the present disclosure. Process 1000 may start at 1005 where low confidence segments are identified. This can be done automatically (e.g., box 305 of process 300) or manually by an operator using human intelligence to identify erroneously transcribed word(s). At 1010, an application program interface (API) can be used to request the HIT service to reanalyze the selected segment(s) at 1005. At 1015, the selected segment(s) can be re-transcribed by the human operator or by using a ground truth engine. Once the low confidence segment has been re-transcribed or re-labelled, it can be sent back with timing information such that it could be reincorporated (e.g., merged) at the proper position with other transcribed portions of the input media file.

FIG. 11 is a system diagram of an exemplary transcription system 1100 for optimizing the selection of one or more transcription engines to transcribe a media file in accordance with some embodiments of the present disclosure. System 1100 may include one or more preprocessor modules 1105, training module 1107, transcription analyzer 1109, modeling module 1110, one or more transcription engines 1115, database 1120, low-confidence database 1127, textual analysis module (or textual analyzer) 1125, communication module 1130, crawler module 1135, ground truth engine 1140, micro engine 1145, and conductor 1150. System 1100 may reside on a single server or may be distributed at various locations on a network. For example, one or more components (e.g., 1105, 1110, 1115, etc.) of system 1100 may be distributed across various locations throughout a network. Each component or module of system 1100 may communicate with each other and with external entities via communication module 1130. Each component or module of system 1100 may include its own sub-communication module to further facilitate with intra and/or inter-system communication.

Preprocessor modules 1105 include algorithms and instructions that, when executed by a processor, cause the processor to perform the respective functions and features of one or more preprocessors as described above with respect, but not limited, to processes 100 and 200.

Training module 1107 includes algorithms and instructions that, when executed by a processor, cause the processor to perform the respective functions and features of training module 200 as describe above and with respect, but not limited, to training related functions of processes 100, 200, and 400.

Transcription analyzer 1109 includes algorithms and instructions that, when executed by a processor, cause the processor to perform the respective functions and features of a transcription analyzer as describe above and with respect to identifying low confidence segment(s) described in, for example, processes 100 (box 125), 300 (box 305), and 500 (box 525).

Modeling module 1110 includes algorithms and instructions that, when executed by a processor, cause the processor to perform the respective functions and features of the modeling module as describe above with respect, but not limited, to processes 100, 200, and 400. In some embodiments, modeling module 1110 is configured generate a ranked list of transcription engines from which one or more engines may be selected to perform transcription of media data files. Modeling module 1110 can generate the ranked list of transcription engines based at least on audio features of the media file. Modeling module 1110 can implement machine learning algorithm(s) to perform the respective functions and features as describe above. Modeling module 1110 can include neural networks such as, but not limited to, a recurrent neural network, a CNN, and a SSD neural network.

In some embodiments, output data from transcription engines 1115 may be accumulated in database 1120 for future training of transcription engines 1115. Database 1120 includes media data sets which may include, for example, customers' ingested data, ground truth data, and training data.

Transcription engines 1115 can include local transcription engine(s) and third-party transcription engines such as engines provided by IBM®, Microsoft®, and Nuance®, for example. Transcription engines 1115 can include specialized engines for medical, sports, movies, law, police, etc. Transcription engines 1115 can also include specialized micro engine described in process 400 and the reinforcement learning transcription engine of process 500.

Textual analyzer or module 1125 includes algorithms and instructions that, when executed by a processor, cause the processor to perform the respective the functions and features of the textual analyzer as describe above with respect, but not limited, to processes 100, 200, and 300. Textual analyzer 1125 can include a contextual analyzer, a grammatical analyzer, a lexical analyzer, a topical analyzer, a word composition analyzer, and a sentiment analyzer. Textual analyzer 1125 can include machine learning algorithm(s) configured to perform contextual, grammatical, lexical, topical, composition, and/or sentiment analyses on a transcribed portion of a transcript, an entire transcript, a segment of a media file, and/or the entire media file.

Crawler module 1135 includes algorithms and instructions that, when executed by a processor, cause the processor to mine appropriate data for used as media files that can be used as input in processes such as 100, 200, and 300.

Truth engine 1140 includes algorithms and instructions that, when executed by a processor, cause the processor to identify transcription errors in one or more parts of a transcribed portion, for example, by identifying words with confidence score below a predetermined threshold. The truth engine 1140 may then correct the identified errors, for example, by replacing the words with low confidence score with correct words. In some embodiments, the truth engine may utilize machine learning model to find the correct replacement words. The truth engine 1140 may also label (or tag) the corrected words.

Conductor 1150 includes algorithms and instructions that, when executed by a processor, cause the processor to perform the respective the functions and features of the conductor as describe above with respect, but not limited, to processes 100, 200, 300, 400, 500, 800, and 1000. For example, conductor 1150 includes algorithms and instructions that, when executed by a processor, cause the processor to: train transcription models based at least on the features profile of the input media file; select a transcription engine based on a trained model to transcribe the input media file; identify one or more segments of the transcribed media file with a low confidence of accuracy or segments that need to be reexamined based on results from textual analyzer 1125; select a new transcription engine to transcribe the one or more segments with a low confidence of accuracy or segments that have been identified as segments that need to be reexamined; select a different transcription engine re-transcribe the identified segments with low confidence or flagged for reexamination; request a HIT service to reanalyze the low confidence segment; request the reinforcement learning enabled model/engine to modify the audio features of the low confidence segment and re-transcribe the segment. Conductor 1150 is also configured to develop a specialized micro engine/model to transcribe one or more segments that cannot be transcribed to a desired level of accuracy by previously selected transcription engines (after several cycles); and transcribe the one or more segments using the specialized micro engine.

HIT & RLM (reinforcement learning enabled transcription model) module 1155 includes algorithms and instructions that, when executed by a processor, cause the processor to perform the respective the functions and features of processes 500 and 1000. HIT & RLM module 1155 can be two separate modules, one for HIT functionalities and one for RLM functionalities.

It should be noted that one or more functions of each of the modules (e.g., 1105, 1107, 1110, 1140) in transcription system 1100 can be shared with another modules within transcription system 1100. For example, the confidence of accuracy for a segment or an entire media file can be determined using transcription analyzer 1109 and/or textual analyzer 1125. In another example, training module 1107 and modeling module 1110 can share one or more training and modeling functionalities. In another example, micro engine module 1145 can be a component of training module 1107 or modeling module 1110. It should also be noted that each engine, for example, 1140 and 1145 may be external to and communicatively coupled to the transcription system 1100.

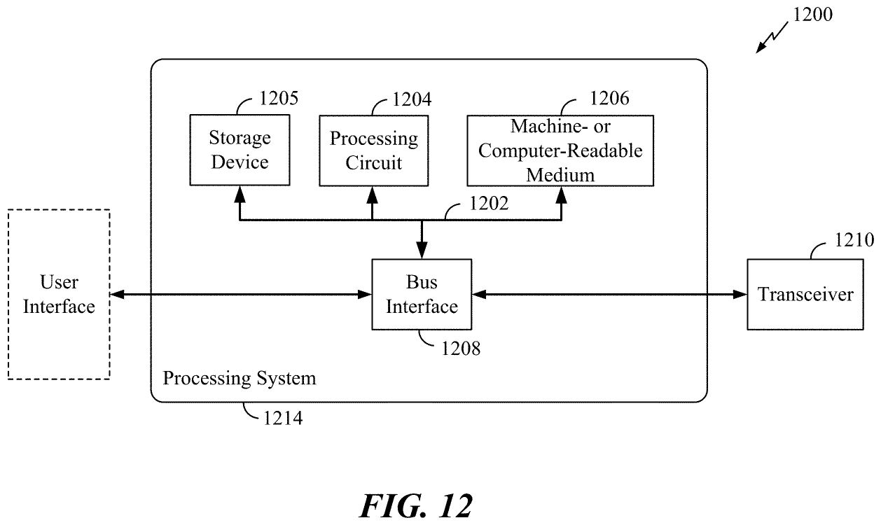

FIG. 12 illustrates an exemplary system or apparatus 1200 in which processes 100, 200, 300, 400, 500, 800 and 100 can be implemented. In accordance with various aspects of the disclosure, an element, or any portion of an element, or any combination of elements may be implemented with a processing system 1214 that includes one or more processing circuits 1204. Processing circuits 1204 may include micro-processing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionalities described throughout this disclosure. That is, the processing circuit 1204 may be used to implement any one or more of the processes described above and illustrated in FIGS. 1-5, 8, 9, 10, and 11.

In the example of FIG. 12, the processing system 1214 may be implemented with a bus architecture, represented generally by the bus 1202. The bus 1202 may include any number of interconnecting buses and bridges depending on the specific application of the processing system 1214 and the overall design constraints. The bus 1202 may link various circuits including one or more processing circuits (represented generally by the processing circuit 1204), the storage device 1205, and a machine-readable, processor-readable, processing circuit-readable or computer-readable media (represented generally by a non-transitory machine-readable medium 1206). The bus 1202 may also link various other circuits such as, but not limited to, timing sources, peripherals, voltage regulators, and power management circuits, which are well known in the art, and therefore, will not be described any further. The bus interface 1208 may provide an interface between bus 1202 and a transceiver 1210. The transceiver 1210 may provide a means for communicating with various other apparatus over a transmission medium. Depending upon the nature of the apparatus, a user interface 1212 (e.g., keypad, display, speaker, microphone, touchscreen, motion sensor) may also be provided.

The processing circuit 1204 may be responsible for managing the bus 1202 and for general processing, including the execution of software stored on the machine-readable medium 1206. The software, when executed by processing circuit 1204, causes processing system 1214 to perform the various functions described herein for any particular apparatus. Machine-readable medium 1206 may also be used for storing data that is manipulated by processing circuit 1204 when executing software.

One or more processing circuits 1204 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

The software may reside on machine-readable medium 1206. The machine-readable medium 1206 may be a non-transitory machine-readable medium. A non-transitory processing circuit-readable, machine-readable or computer-readable medium includes, by way of example, a magnetic storage device (e.g., solid state drive, hard disk, floppy disk, magnetic strip), an optical disk (e.g., digital versatile disc (DVD), Blu-Ray disc), a smart card, a flash memory device (e.g., a card, a stick, or a key drive), RAM, ROM, a programmable ROM (PROM), an erasable PROM (EPROM), an electrically erasable PROM (EEPROM), a register, a removable disk, a hard disk, a CD-ROM and any other suitable medium for storing software and/or instructions that may be accessed and read by a machine or computer. The terms “machine-readable medium”, “computer-readable medium”, “processing circuit-readable medium” and/or “processor-readable medium” may include, but are not limited to, non-transitory media such as, but not limited to, portable or fixed storage devices, optical storage devices, and various other media capable of storing, containing or carrying instruction(s) and/or data. Thus, the various methods described herein may be fully or partially implemented by instructions and/or data that may be stored in a “machine-readable medium,” “computer-readable medium,” “processing circuit-readable medium” and/or “processor-readable medium” and executed by one or more processing circuits, machines and/or devices. The machine-readable medium may also include, by way of example, a carrier wave, a transmission line, and any other suitable medium for transmitting software and/or instructions that may be accessed and read by a computer.

The machine-readable medium 1206 may reside in the processing system 1214, external to the processing system 1214, or distributed across multiple entities including the processing system 1214. The machine-readable medium 1206 may be embodied in a computer program product. By way of example, a computer program product may include a machine-readable medium in packaging materials. Those skilled in the art will recognize how best to implement the described functionality presented throughout this disclosure depending on the particular application and the overall design constraints imposed on the overall system.

One or more of the components, processes, features, and/or functions illustrated in the figures may be rearranged and/or combined into a single component, block, feature or function or embodied in several components, steps, or functions. Additional elements, components, processes, and/or functions may also be added without departing from the disclosure. The apparatus, devices, and/or components illustrated in the Figures may be configured to perform one or more of the methods, features, or processes described in the Figures. The algorithms described herein may also be efficiently implemented in software and/or embedded in hardware.

Note that the aspects of the present disclosure may be described herein as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and processes have been described above generally in terms of their functionality. Whether such functionality is implemented as hardware or software depends upon the particular application and design constraints imposed on the overall system.

The embodiments described above are considered novel over the prior art and are considered critical to the operation of at least one aspect of the disclosure and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described above are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

In the foregoing description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used above, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B”, when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, processes, operations, values, and the like.

1. A method for transcribing a media file, the method comprising:
identifying a low confidence of accuracy portion from a transcription result of the media file;
constructing a phoneme sequence that includes an audio segment corresponding to the identified low confidence of accuracy portion, based on at least on a reward function;
creating a new audio waveform based at least on the constructed phoneme sequence; and
generating a new transcription using a transcription engine based on the new audio waveform.

2. The method of claim 1, further comprising:
generating a string of cumulants comprising of one or more transcription portions preceding and following the low confidence of accuracy portion, wherein the constructed phoneme sequence is based at least one the string of cumulants; and
generating a reward function based at least on one or more characteristics of the transcription engine.

3. The method of claim 2, wherein generating the reward function comprises learning characteristics of the transcription engine by computing a Shannon entropy.

4. The method of claim 2, wherein generating the reward function comprises solving a Bellman equation using backward induction.

5. The method of claim 2, wherein generating the reward function comprises solving a Bellman equation using backward induction.

6. The method of claim 5, wherein the Bellman equation comprises a Dempster Shafer possibility transition matrix.

7. The method of claim 5, wherein the Bellman equation comprises:
$$V ( y , t ) = {max}_{u} \{ {\sum }_{{y}^{′}} {P}_{{yy}^{′}} ( {u}_{t} ) \cdot V ( {y}^{′} , t + 1 ) - L ( y , u , t ) \} ,$$
wherein V comprises the reward function, y comprises a state, u comprises an action vector, P_{yy′} comprises the Dempster Shafer possibility transition matrix, and L comprises a Shannon entropy.

8. The method of claim 1, the reward function comprises a function of a state and an action vector, wherein the action vector comprises one or more parameters consisting of a treble, a bass, an average amplitude, a deviation, a frequency discriminant, coefficient of amplitude modulation, coefficient of phase modulation, a waveform frequency, a pitch, a spectral flax, and mel frequency cepstral coefficients (MFCC) of the waveform.

9. The method of claim 1, wherein identifying a low confidence of accuracy portion comprises evaluating a confidence value of each transcribed portion.

10. The method of claim 9, wherein the confidence value of each transcribed portion is calculated based at least on one or more of ground truth data, wavelet transform coefficients, entropy of the signal, and an energy distribution of an audio segment corresponding to the low confidence of accuracy portion.

11. A system for transcribing a media file, the system comprising:
a transcription engine;
a classifier module configured to identify a first low-accuracy transcribed portion, wherein the first low-accuracy has a confidence of accuracy value below an accuracy threshold;
a cumulant module configured to generate a cumulant string based on the first low-accuracy transcribed portion;
a reinforcement learning (RL) module configured to generate a reward function based on one or more characteristics of the transcription engine;
a phoneme sequence construction module configured to construct one or more phoneme sequences based on the reward function and the cumulant string; and
a microphone module configured to generate an audio waveform from the one or more phoneme sequences, wherein the transcription engine is configured to generate transcription based on the audio waveform.

12. The system of claim 11, wherein the reinforcement learning module is configured to generate the reward function by solving an optimization function that comprises a Bellman equation.

13. The system of claim 12, wherein the Bellman equation comprises a Dempster Shafer possibility transition matrix.

14. The system of claim 12, wherein the Bellman equation comprises:
$$V ( y , t ) = {max}_{u} \{ {\sum }_{{y}^{′}} {P}_{{yy}^{′}} ( {u}_{t} ) \cdot V ( {y}^{′} , t + 1 ) - L ( y , u , t ) \} ,$$
wherein V comprises the reward function, y comprises a state, u comprises an action vector, P_{yy′} comprises the Dempster Shafer possibility transition matrix, and L comprises a Shannon entropy.

15. The system of claim 14, wherein Dempster Shafer the possibility matrix and the reward function can be derived using backward induction.

16. The system of claim 12, wherein the phoneme sequence construction module is configured to modify, based at least in part on the reward function, one or more a treble, a bass, an average amplitude, a deviation, a frequency discriminant, coefficient of amplitude modulation, coefficient of phase modulation, a frequency, a pitch, a spectral flax, and mel frequency cepstral coefficients (MFCC) of the waveform.

17. The system of claim 11, wherein the classifier module is configured to identify the first low-accuracy transcribed portions by evaluating one or more of a confidence value of each transcribed word, corresponding ground truth data, wavelet transform coefficients, entropy of the signal, and an energy distribution of an audio waveform corresponding to first low-accuracy transcribed portion.

18. The system of claim 11, wherein the reinforcement learning module is configured to compute a Shannon entropy to learn characteristics of the transcription engine.

19. The system of claim 11, wherein the microphone module configured to generate an audio waveform using one or more transfer functions.

20. A system for transcribing a media file, the system comprising:
a memory;
one or more processors coupled to the memory, the one or more processors configured to:
identify a low confidence of accuracy portion from a transcription result of the media file;
construct a phoneme sequence that includes an audio segment corresponding to the identified low confidence of accuracy portion, based on at least on a reward function;
create a new audio waveform based at least on the constructed phoneme sequence; and
generate a new transcription using a transcription engine based on the new audio waveform.
